(19) United States
(12) Patent Application Publication
(10) Pub. No.: US 2015/0256294 A1
(43) Pub. Date: Sep. 10, 2015

(54) TRANSMISSION APPARATUS

(71) Applicant: FUJITSU LIMITED, Kawasaki-shi (JP)

(72) Inventors: TAKUMI KIKUGAWA, Fukuoka (JP); KENICHI OHYAMA, Fukuoka (JP); EIJI GOBARU, Fukuoka (JP)

(21) Appl. No.: 14/614,670

(22) Filed: Feb. 5, 2015

(30) Foreign Application Priority Data
Mar. 4, 2014 (JP) 2014-041634

(51) Int. Cl. H04L 1/00; H04L 29/06

(52) U.S. Cl. CPC H04L 1/0083; H04L 69/22

(57) ABSTRACT

A transmission apparatus includes a detection unit, an error determination unit, a conversion unit, and a deletion unit. The detection unit detects a header in a frame. The error determination unit determines whether or not an error exists in the header detected by the detection unit. The conversion unit converts the frame into a transmission frame to be transmitted to another transmission apparatus when the error determination unit determines that the error exists. The deletion unit deletes the transmission frame.

### CROSS-REFERENCE TO RELATED APPLICATION

This application is based upon and claims the benefit of priority of the prior Japanese Patent Application No. 2014-041634, filed on Mar. 4, 2014, the entire contents of which are incorporated herein by reference.

### FIELD

The embodiments discussed herein are related to a transmission apparatus.

### BACKGROUND

Transmission apparatus that performs multiplex communication of frames using a Synchronous Optical NETwork (SONET) or an Optical channel Transport Unit (OTU) has been used. A transmission apparatus receives a Generic Framing Procedure (GFP) frame including plural GFP client frames from a network side and generates a transmission GFP client frame from the GFP frame to transmit to a client side. Concretely, upon receiving a GFP frame, the transmission apparatus extracts plural GFP client frames from the GFP frame and detects a core header of each GFP client frame. In the core header, a Payload Length Indicator (PLI) that indicates a payload length of the frame and a cHEC are stored. The transmission apparatus switches methods for generating a transmission GFP client frame from the GFP client frame according to whether or not the cHEC is normal.

Concretely, when the cHEC is normal, the transmission apparatus generates a transmission GFP client frame including a payload length indicated by the PLI by demapping the GFP client frame. In this case, a GFP client frame which does not include a payload part (hereinafter, referred to as a “GFP Idle frame” to distinguish from the general GFP client frame) is deleted. Here, even when there is an error in the detected core header, if the error is a single-bit error, the transmission apparatus generates a transmission GFP client frame having a payload length indicated by PLI after an error correction and transmits the frame to the client, similarly to the case when the cHEC is normal.

[Patent Document 1] Japanese Laid-open Patent Publication No. 2003-008532

[Patent Document 2] Japanese Laid-open Patent Publication No. 2005-006036

However, when the cHEC is not normal, in other words, when there is a multibit error in the core header, the GFP client frame is recognized as an error frame (hereinafter, referred to as “GFP error frame”). Then, the transmission apparatus once generates a transmission GFP client frame including a false payload length indicated by the PLI and applies an error flag to the frame. The transmission GFP client frame applied with the error flag is deleted (discarded) as a GFP error frame in another transmission apparatus (a post stage circuit) connected in the client side.

In other words, in the related transmission apparatus, even when a false value is set in a core header, demapping (generating a GFP error frame) is executed based on the false value and this may cause a problem as follows, for example. In a case that there is a multibit error in a core header of a GFP client frame or a GFP Idle frame, when the payload length indicated by the PLI is larger than the original payload length, a subsequent normal transmission GFP client frame is vanished.

For example, in a case that a PLI value of a GFP client frame is “0x0070” which is two bits garbled from an original value of “0x0052” before arriving to the transmission apparatus, the transmission apparatus generates a GFP error frame as including a subsequent GFP client frame when demapping. With this, the GFP client frame which is not an error frame is recognized as a part of the GFP error frame and deleted. As a result, in some cases, a normal GFP client frame is vanished and a transmission GFP client frame which has to be generated is not generated. Such an intermission of a transmission GFP client frame may be a factor to lower the performance or reliability of the transmission apparatus.

Here, in a case of a GFP Idle frame, a problem same as the above GFP client frame may occur.

### SUMMARY

According to an aspect of the embodiments, a transmission apparatus includes: a detection unit that detects a header in a frame; an error determination unit that determines whether or not an error exists in the header detected by the detection unit; a conversion unit that converts the frame into a transmission frame to be transmitted to another transmission apparatus when the error determination unit determines that the error exists; and a deletion unit that deletes the transmission frame.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a structure of a transmission apparatus according to an embodiment;

FIG. 2 is a flowchart for explaining an operation of the transmission apparatus according to the embodiment;

FIG. 3A is a diagram illustrating a GFP client frame before demapping when cHEC is normal;

FIG. 3B is a diagram illustrating a GFP client frame after demapping when cHEC is normal;

FIG. 4A is a diagram illustrating a GFP client frame before demapping when cHEC is not normal;

FIG. 4B is a diagram illustrating a GFP client frame after demapping when cHEC is not normal;

FIG. 5 is a block diagram illustrating a structure of a transmission apparatus according to a modification example; and

FIG. 6 is a flowchart for explaining an operation of the transmission apparatus according to the modification example.

### DESCRIPTION OF EMBODIMENTS

Preferred embodiments will be explained with reference to accompanying drawings. It is noted that the transmission apparatus disclosed in this application is not limited by the following embodiment.

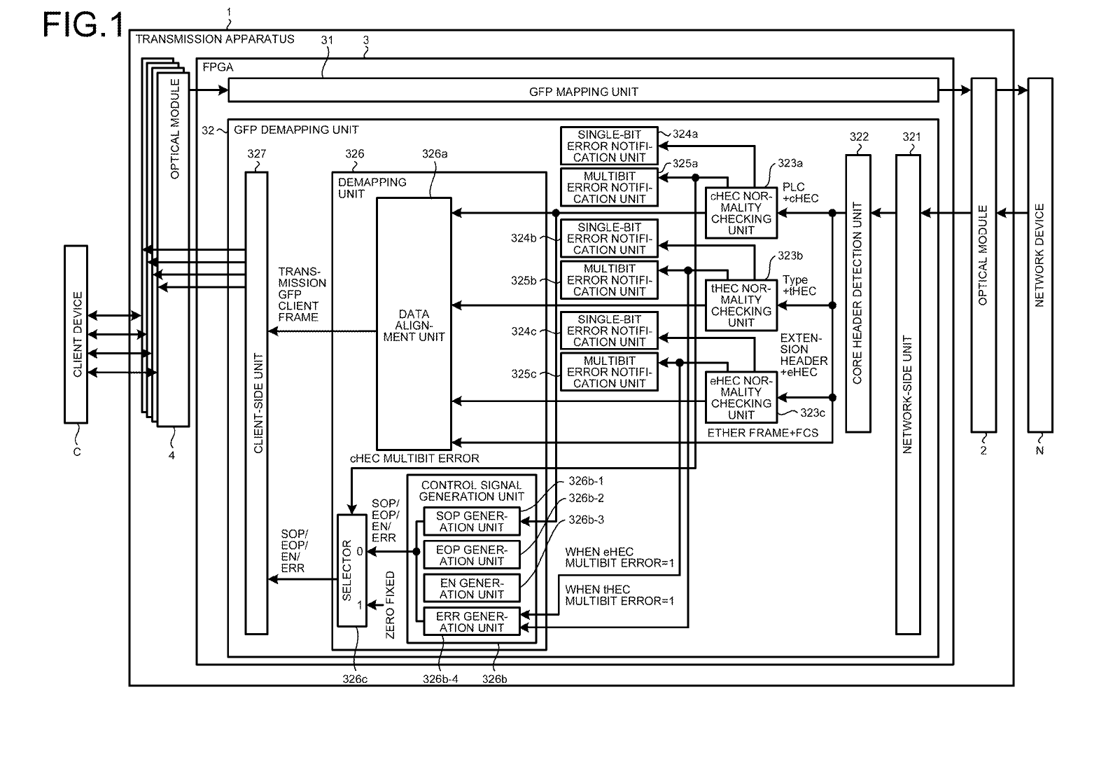

Firstly, a structure of a transmission apparatus according to the embodiment disclosed in this application will be explained. FIG. 1 is a block diagram illustrating a structure of a transmission apparatus 1 according to the embodiment. As illustrated in FIG. 1, the transmission apparatus 1 includes an optical module 2, a Field Programmable Gate Array (FPGA) 3, and an optical module 4. The optical module 2 converts an optical signal received by the transmission apparatus 1 into an electrical signal. Even when there is a multibit error in a core header of a GFP client frame included in a received GFP frame, the FPGA 3 performs demapping of the GFP client frame without generating a GFP error frame. This prevents a normal GFP client frame subsequent to the GFP client frame from being affected by the GFP error frame and deleted in a later step, when generating a transmission GFP client frame in the FPGA 3. The optical module 4 again converts the electrical signal into an optical signal.

Here, the FPGA 3 may be an Application Specific Integrated Circuit (ASIC), a Network Processing Unit (NPU) or the like, for example.

The FPGA 3 includes a GFP mapping unit 31 and a GFP demapping unit 32. For example, the GFP mapping unit 31 performs mapping of a client signal transmitted from a client device C to a GFP frame and transmits the GFP frame to a network device N. For example, the GFP demapping unit 32 generates a transmission GFP client frame by demapping plural GFP client frames included in the GFP frame transmitted from the network device N and transmits the frame to the client device C.

Here, for example, the client signal is an Ethernet (Registered trademark) signal or an Internet Protocol (IP)/Point to Point Protocol (PPP) signal in ITU-T G.7041/Y.1303 Figure 1 GFP relationship to client signals and transport paths; however, other signals may be used.

As illustrated in FIG. 1, the GFP demapping unit 32 includes a network-side unit 321, a core header detection unit 322, normality checking units 323a, 323b, 323c, single-bit error notification units 324a, 324b, 324c, and multibit error notification units 325a, 325b, 325c. These respective components are connected unidirectionally or bi-directionally so that signals and frames can be input and output.

The network-side unit 321 receives a GFP frame from a network side and extracts plural GFP client frames from the GFP frame. The core header detection unit 322 detects a core header in the GFP client frame. The cHEC normality checking unit 323a checks normality of a cHEC in the detected core header. Similarly, the tHEC normality checking unit 323b checks normality of a tHEC in the detected core header. In the same manner, the eHEC normality checking unit 323c checks normality of an eHEC in the detected core header. The single-bit error notification units 324a, 324b and 324c respectively notify an occurrence of a single-bit error based on the normality check results by the normality checking units 323a, 323b and 323c. Further, the multibit error notification units 325a, 325b and 325c respectively notify an occurrence of a multibit error based on the normality check results by the normality checking units 323a, 323b and 323c.

Further, as illustrated in FIG. 1, the GFP demapping unit 32 further includes a demapping unit 326 and a client-side unit 327. The demapping unit 326 includes a data alignment unit 326a, a control signal generation unit 326b, and a selector 326c. The control signal generation unit 326b includes a Start Of Packet (SOP) generation unit 326b-1, an End Of Packet (EOP) generation unit 326b-2, an ENable (EN) generation unit 326b-3, and an ERR generation unit 326b-4. These respective components are connected unidirectionally or bi-directionally so that signals or frames can be input and output.

The data alignment unit 326a forms a GFP client frame in which the core header is positioned at a top part of a 16-byte boundary (a position at Row=1) using a normality check result of a core header detected by the core header detection unit 322, an ether frame, and a Frame Check Sequence (FCS). The SOP generation unit 326b-1 generates each control signal of the SOP, End Of Packet (EOP), and ENable (EN) based on the normality check result by the cHEC normality checking unit 323a and referring to a PLI. When an eHEC multibit error or a tHEC multibit error is “1,” the ERR generation unit 326b-4 generates a control signal of an ERRor Flag (ERR). When detecting a cHEC multibit error, the selector 326c fixedly outputs “0” as the respective control signals (SOP, EOP, EN, ERR). The client-side unit 327 extracts a client signal from the transmission GFP client frame based on the above control signals.

Next, operation will be explained.

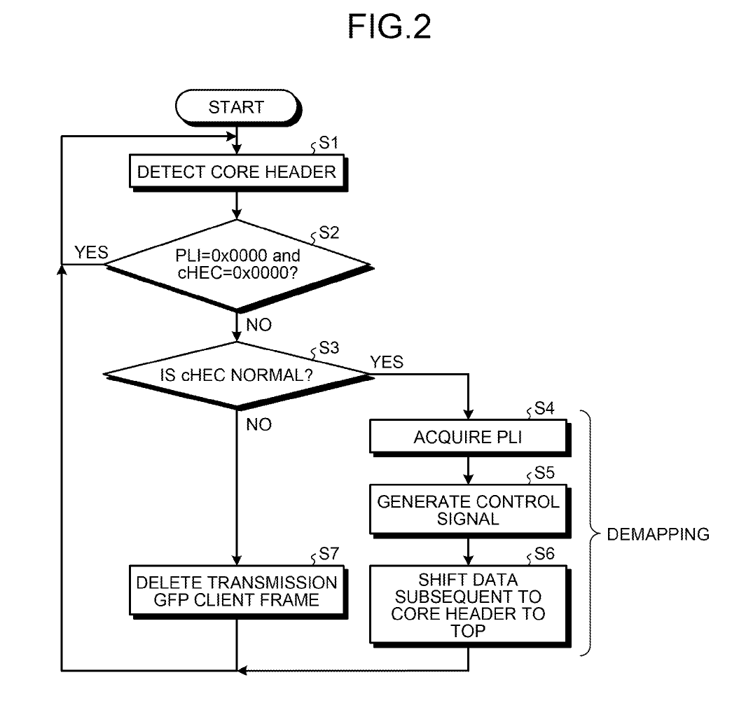

FIG. 2 is a flowchart explaining an operation of the transmission apparatus 1 according to the embodiment. Firstly, in S1, from the GFP client frame extracted from the received GFP frame, the core header detection unit 322 detects a core header (PLI, cHEC) positioned at the top of the frame. In next S2, the core header detection unit 322 checks the values of the PLI and cHEC included in the core header detected in S1 and determines that the GFP client frame is a GFP Idle frame when both of the values are “0x0000” (S2; Yes). After that, returning back to S1, the core header detection unit 322 detects a core header in a next GFP client frame.

On the other hand, as a result of the checking in S2, when the value of the PLI or the value of the cHEC or both of them are not “0x0000” (S2; No), the cHEC normality checking unit 323a determines the normality of the cHEC (S3). As a result of this determination, when the cHEC is normal (S3; Yes), the cHEC normality checking unit 323a acquires the PLI from the core header (S4).

In S5, the control signal generation unit 326b acquires the PLI from the cHEC normality checking unit 323a and generates control signals of SOP, EOP and EN based on the PLI. Particularly, when the tHEC normality checking unit 323b or the eHEC normality checking unit 323c detects that there is a multibit error in the core header, the ERR generation unit 326b-4 in the control signal generation unit 326b generates a control signal of ERR in addition to the above SOP, EOP and EN.

In S6, the data alignment unit 326a forms a GFP client frame by shifting data following the core header to a top part (the position at Row=1) of a 16-byte boundary. Then, the data alignment unit 326a outputs the formed GFP client frame, as a transmission GFP client frame, to the client-side unit 327.

Further, as a result of the determination in S3, when the cHEC is not normal (S3; No), that is, when a multibit error (cHEC multibit error) in the core header is found, the selector 326c fixedly outputs “0” as a control signal. When the control signal is input, the client-side unit 327 deletes (discards) the transmission GFP client frame including the core header as a GFP error frame (S7).

Here, returning back to S1 after the processes in S6 and S7 are completed, the core header detection unit 322 detects a core header in a next GFP client frame.

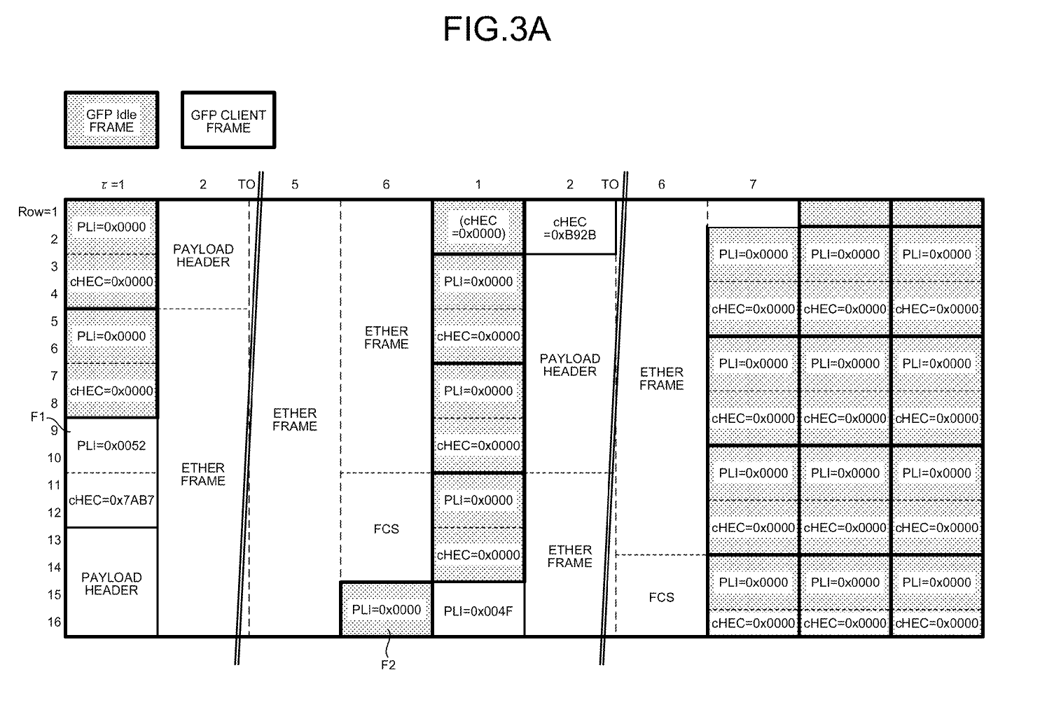

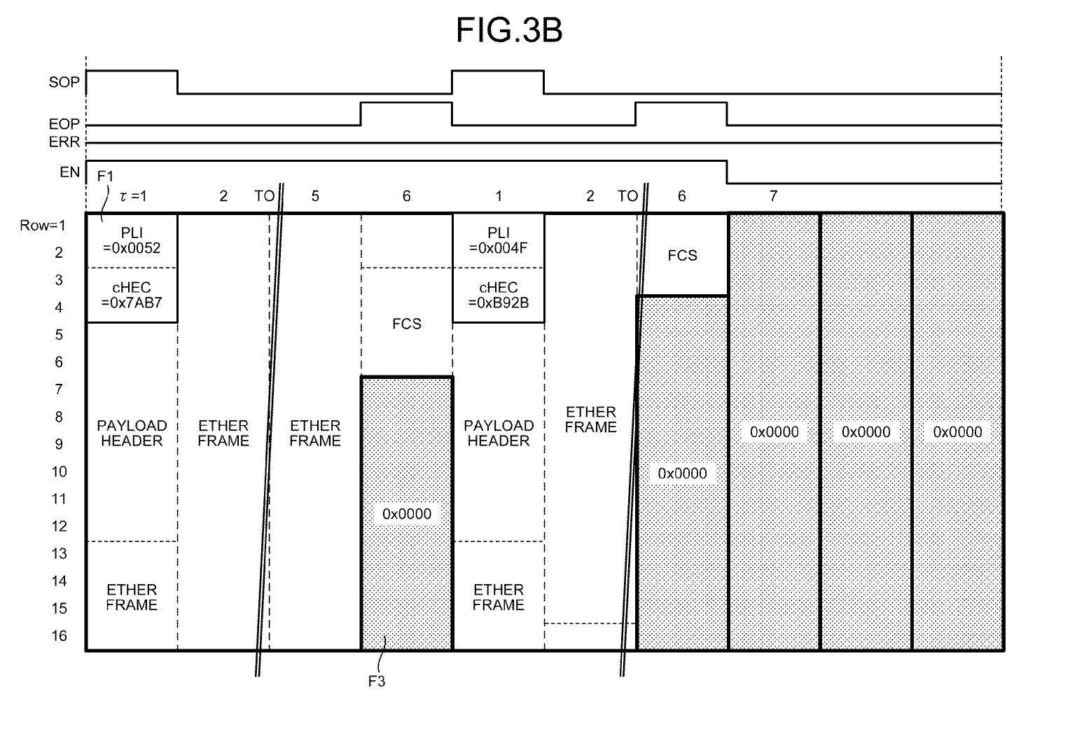

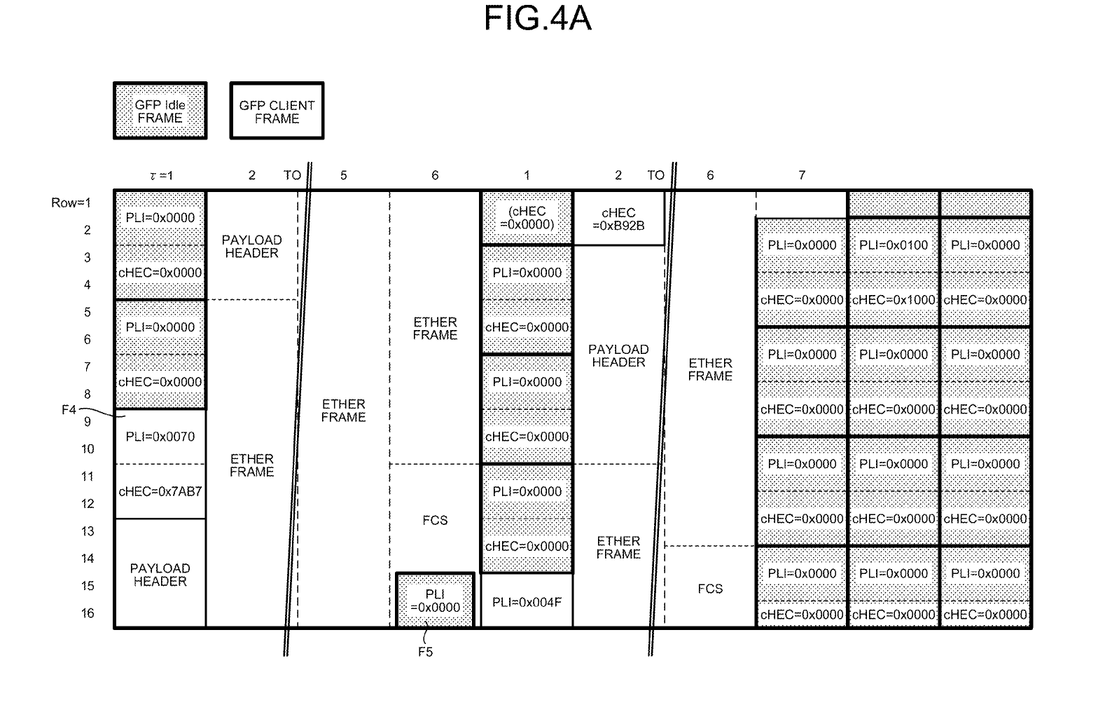

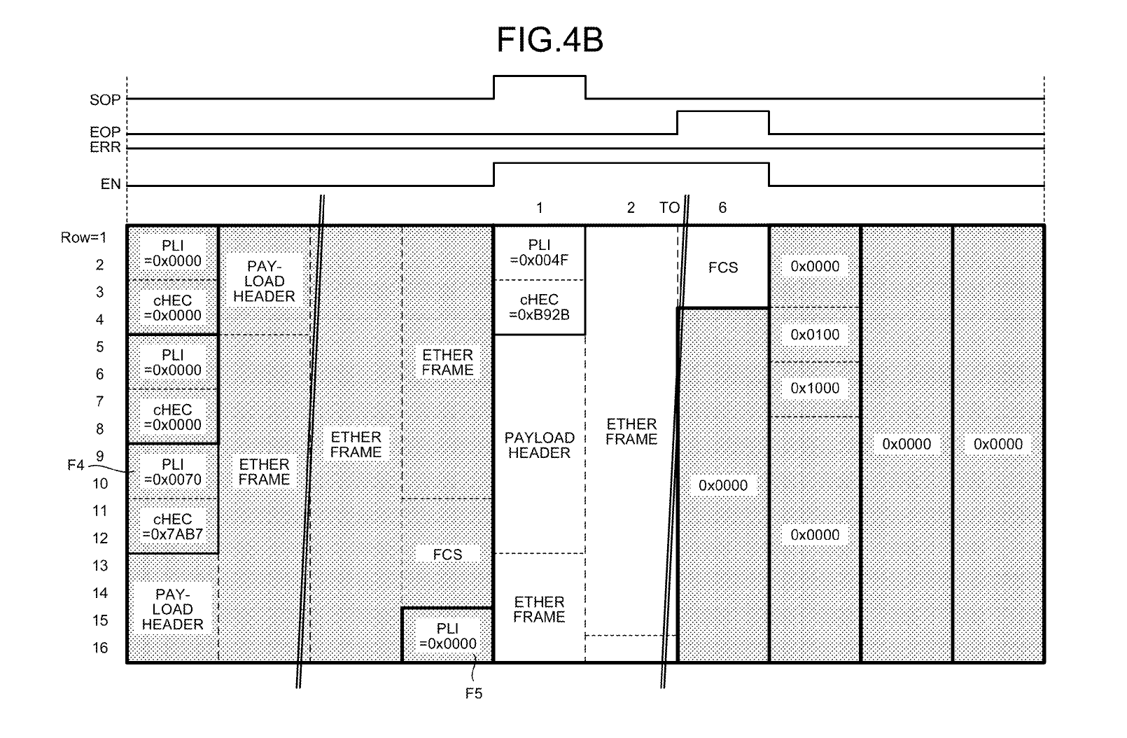

Next, with reference to FIG. 3A to FIG. 4B, the demapping process from S4 to S6 will be explained in further detail. FIG. 3A is a diagram illustrating GFP client frames F1 and F2 before demapping when the cHEC is normal. FIG. 3B is a diagram illustrating GFP client frames F1 and F3 after demapping when the cHEC is normal. As illustrated in FIG. 3A, for example, the GFP client frame F1 having “0x0052” as a PLI and “0x7AB7” as a cHEC is formed so that the PLI is positioned at Row=1 in FIG. 3B. Further, in FIG. 3A, for example, the GFP client frame F2 including “0x0000” as a PLI and “0x0000” as a cHEC is demapped as the GFP Idle frame F3 and becomes a target to be deleted as illustrated in FIG. 3B.

FIG. 4A is a diagram illustrating GFP client frames F4 and F5 before demapping when the cHEC is not normal. FIG. 4B is a diagram illustrating GFP client frames F4 and F5 after demapping when the cHEC is not normal. As illustrated in FIG. 4A, for example, the GFP client frame F4 including “0x0070” as an error PLI and “0x7AB7” as a cHEC is demapped without being formed as illustrated in FIG. 4B. Further, in FIG. 4A, for example, the GFP client frame F5 including “0x0000” as a PLI and “0x0000” as a cHEC is demapped as the GFP Idle frame F5 and becomes a target to be deleted as illustrated in FIG. 4B.

As illustrated in FIG. 4B, the transmission apparatus 1 according to the embodiment sets as SOP=EOP=EN=ERR=0, and does not generate a control signal even when the PLI value of the GFP client frame has two bits garbled from the original “0x0052” to “0x0070”, for example. This prevents generation of a GFP error frame. Similarly, in a GFP Idle frame, for example, even when the PLI value and the cHEC value have two bits garbled from the original “0x0000” and “0x0000” to “0x0100” and “0x1000”, the transmission apparatus 1 does not generate a GFP error frame.

As explained above, the transmission apparatus 1 includes the core header detection unit 322, the cHEC normality checking unit 323a, the demapping unit 326, and the client-side unit 327. The core header detection unit 322 detects a header from the GFP client frame F1. The cHEC normality checking unit 323a determines whether or not an error exists in the header detected by the core header detection unit 322. Even when the cHEC normality checking unit 323a determines that the error exists, the demapping unit 326 converts (performs demapping) the frame into a transmission GFP client frame to be transmitted to the client device C without generating a GFP error frame. The client-side unit 327 deletes the transmission GFP client frame by fixedly outputting “0” as control signals. Further, the above frame may be a frame which does not include a payload part (for example, a GFP Idle frame F3). Further, the error may be an error of two or more bits (for example, a cHEC multibit error).

In other words, when there is a multibit error in a core header of the input GFP client frame or GFP Idle frame, the transmission apparatus 1 does not generate a control signal (SOP, EOP, EN, ERR). With this structure, since the transmission apparatus 1 does not generate a GFP error frame on purpose, it is prevented that the GFP error frame is recognized as a transmission GFP client frame in a post stage circuit. It is thus prevented that a transmission band is wasted by transmission of unnecessary GFP error frames. It is also prevented in advance that normal GFP client frames transmitted after the GFP error frame are affected by the GFP error frame and deleted. As a result, the transmission performance of the transmission apparatus 1 is improved.

### Modification Example

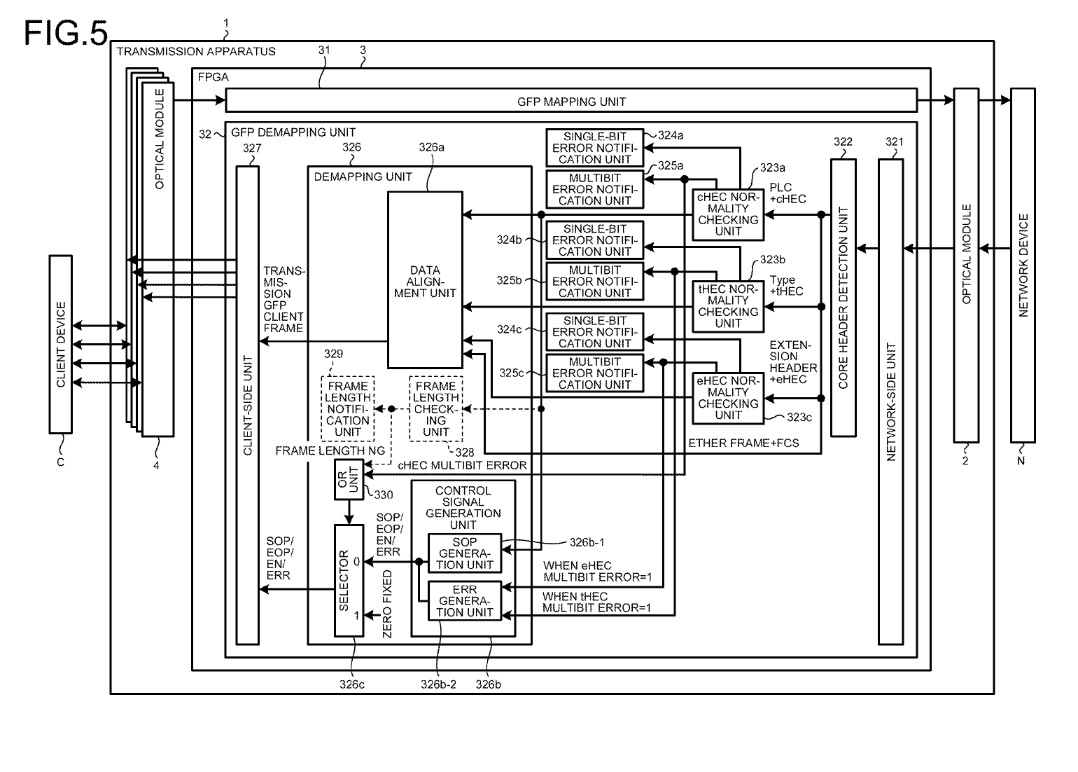

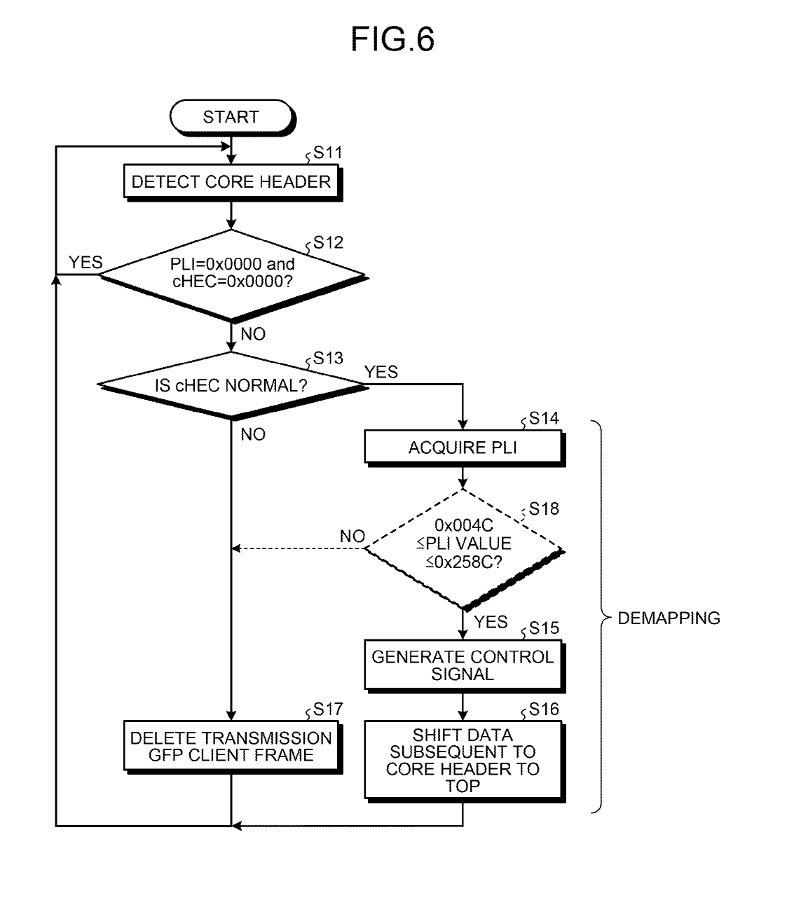

Next, with reference to FIG. 5 and FIG. 6, a modification example will be explained. FIG. 5 is a block diagram illustrating a structure of a transmission apparatus 1 according to the modification example. As illustrated in FIG. 5, the transmission apparatus 1 according to the modification example has the same structure as the transmission apparatus 1 according to the embodiment illustrated in FIG. 1, except for including a frame length checking unit 328 and a frame length notification unit 329, which are illustrated with dotted line, and an OR unit 330. Thus, in this modification example, same numeral numbers are used for the same components as those in the above embodiment and the detailed explanations thereof will be omitted.

The difference from the above embodiment in this modification example is a case of deleting (discarding) a transmission GFP client frame. Concretely, in the above embodiment, the client-side unit 327 of the transmission apparatus 1 is made to delete a transmission GFP client frame including an error only when the cHEC is not normal. On the other hand, according to the modification example, regardless of the normality of the cHEC, in other words, even when there is no error in the GFP client frame, the client-side unit 327 of the transmission apparatus 1 deletes the transmission GFP client frame if the frame length is not within a predetermined range. In the following, the difference from the above embodiment will be mainly explained.

The frame length checking unit 328 determines whether or not the PLI value is equal to or more than “0x004C” and equal to or less than “0x258C” with reference to the PLI included in the core header. Based on the determination result, the frame length notification unit 329 notifies whether or not the frame length of the GFP client frame is within the predetermined range to the OR unit 330. When the cHEC is not normal or when the frame length is not within the predetermined range, the OR unit 330 instructs the selector 326c to fixedly output “0” each as control signals (SOP, EOP, EN, ERR).

FIG. 6 is a flowchart explaining an operation of the transmission apparatus 1 according to the modification example. Since FIG. 6 includes processes same as those in FIG. 2 referred in the explanation of the operation according to embodiment, the common steps are applied with the reference numbers having the same last digits as those in the common steps in FIG. 2, and the detailed explanation will be omitted. Concretely, the processes of steps S11 to S17 in FIG. 6 correspond to the processes of step S1 to S7 illustrated in FIG. 2 respectively.

In S18, the frame length checking unit 328 refers to the PLI value obtained in S14 and determines whether or not it satisfies a condition, 0x004C≦PLI value≦0x258C. As a result of the determination, when the condition 0x004C≦PLI value≦0x258C is satisfied (S18; Yes), the process proceeds to S15. In other words, the control signal generation unit 326b obtains the PLI from the cHEC normality checking unit 323a and generates control signals of SOP, EOP and EN based on the PLI. On the other hand, the condition 0x004C≦PLI value≦0x258C is not satisfied (S18; No), the process proceeds to S17. In other words, the selector 326c fixedly outputs “0” as the control signals. When the control signal is input, the client-side unit 327 deletes the transmission GFP client frame regardless of the existence of an error in the GFP client frame.

As described above, the transmission apparatus 1 according to the modification example further includes the frame length checking unit 328. The frame length checking unit 328 determines whether or not the frame length of the GFP client frame is within a predetermined range. When it is determined by the frame length checking unit 328 that the frame length is not within the predetermined range, the client-side unit 327 converts the GFP client frame and deletes the generated transmission GFP client frame by fixedly outputting “0” as control signals.

The frame length of a normal GFP client frame is specified to be equal to or longer than 8 bytes and equal to or shorter than 65539 bytes. Thus, the GFP client frame including a frame length which is out of the range is usually deleted by a Media Access Control (MAC) function which is implemented in a post stage circuit. As described above, in the transmission apparatus 1 according to the modification example, the transmission apparatus 1 can delete an abnormal GFP client frame in a step of a demapping process since the demapping unit 326 has a function for checking the frame length. This prevents an occurrence of wasted band in post stage circuits.

Here, in the modification example, since the minimum value of the frame length is set as 64 bytes, the lower limit of PLI is set as PLI=0x004C (76 bytes=payload header: 8 bytes+ether frame: 64 bytes+payload FCS: 4 bytes); however, the lower limit of PLI may be other values. Similarly, regarding an upper limit, since the maximum value of the frame length is set as 9600 bytes, the upper limit of PLI is set as PLI=0x258C (9612 bytes=payload header: 8 bytes+ether frame: 9600 bytes+payload FCS: 4 bytes); however, the upper limit of PLI may be other values.

Further, according to the modification example, deletion of the transmission GFP client frame by the transmission apparatus 1 has been described with a case that the cHEC is not normal and a case that the frame length is not within the predetermined range; however, the deletion may be executed only in the latter case.

According to the embodiment and the modification example, frames are considered as a Protocol Data Unit (PDU); however, it is not limited to this example. For example, according to the network type, the embodiment and the modification example may be applied to other PDUs such as a packet of Transmission Control Protocol/Internet Protocol (TCP/IP), a cell of Asynchronous Transfer Mode (ATM) and the like.

Further, according to the embodiment and the modification example, when determining whether or not an error exits in a core header, the transmission apparatus 1 determines that an error exists when there is an error of two or more bits (multibit error). However, in addition to this example, the transmission apparatus 1 may be made to delete a transmission GFP client frame when there is an error of three or more bits or an error of other number of bits. Further, the transmission apparatus 1 is made to determine whether to delete the transmission GFP client frame based on the normality of a cHEC of a core header. However, in addition to this example, the transmission apparatus 1 may determine whether to delete the transmission GFP client frame based on the normality of the tHEC or eHEC.

Further, according to the embodiment and the modification example, the respective components of the transmission apparatus 1 do not need to be physically composed as illustrated in the drawings. In other words, the concrete manner of the distribution and integration of the respective devices is not limited to what is illustrated in the drawings and all or a part of it may be composed by functionally or physically distributing or integrating by any unit according to various loads or usage conditions. For example, the cHEC normality checking unit 323a, the tHEC normality checking unit 323b, and the eHEC normality checking unit 323c, or the SOP generation unit 326b-1 and ERR generation unit 326b-4 of the control signal generation unit 326b may be integrated as single components respectively. On the contrary, regarding the data alignment unit 326a, a section for forming a GFP client frame and a section for outputting a transmission GFP client frame to the client-side unit 327 may be separately provided. Further, a memory that stores a frame or a control signal may be provided as an external device of the transmission apparatus 1 and connected via a network or a cable.

With an aspect of the transmission apparatus disclosed in this application, transmission performance can be improved.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a detection unit that detects a header in a frame;
an error determination unit that determines whether or not an error exists in the header detected by the detection unit;
a conversion unit that converts the frame into a transmission frame to be transmitted to another transmission apparatus when the error determination unit determines that the error exists; and
a deletion unit that deletes the transmission frame.

2. The transmission apparatus according to claim 1, wherein the frame is a frame which does not include a payload part.

3. The transmission apparatus according to claim 1, wherein the error is an error of two or more bits.

4. The transmission apparatus according to claim 1, further including a frame length determination unit that determines whether or not a frame length of the frame is within a predetermined range,
wherein, when it is determined by the frame length determination unit that the frame length is not within the predetermined range, the deletion unit deletes the generated transmission frame by converting the frame.
